(19) United States
(12) Patent Application Publication
(10) Pub. No.: US 2022/0383329 A1
(43) Pub. Date: Dec. 1, 2022

(54) Predictive Customer Satisfaction System And Method

(71) Applicant: Dialpad, Inc., San Ramon, CA (US)

(72) Inventors: Etienne Manderscheid, Niwot, CO (US); Matthias Ming Zhao Lee, Columbia (CA); Douglas Gould Franklin Mackenzie, Vancouver (CA)

(21) Appl. No.: 17/333,065

(22) Filed: May 28, 2021

(51) Int. Cl. G06Q 30/00; G06Q 30/02; H04M 3/51; H04M 3/523; G06F 40/30; G10L 15/26; G06N 20/00

(52) U.S. Cl. CPC G06Q 30/016; G06Q 30/0202; H04M 3/5175; H04M 3/5233; G06F 40/30; G10L 15/26; G06N 20/00; H04M 2203/401

(57) ABSTRACT

A computer-implemented method of predicting customer satisfaction scores for a call center is disclosed, along with the use of the predicted customer satisfaction scores to perform various analytical functions, such as identifying changes to the predicted customer satisfaction score and identifying root causes of the predicted customer satisfaction scores. In some implementations, a pipeline includes an inference engine that includes an AI model trained on call transcripts and call attribute data to predict a customer satisfaction score.

### FIELD OF THE INVENTION

The present disclosure generally relates to predicting customer satisfaction. More specifically, the present disclose relates to using predicted customer satisfaction for a variety of purposes, including performing a root cause analysis of factors related to customer satisfaction.

### BACKGROUND

Customer relations are an important part of many businesses. Many businesses interact with customers through contact call centers. For example, in a ticketing paradigm, tickets are generated that track a client support issue from initial customer contact to completion of the call. For example, customers may interact with agents who answer questions, address complaints, or resolve support issues that customers have.

A variety of practical problems arise with regards to determining customer satisfaction (CSAT). Many companies survey customers to obtain CSAT data. However, there are a variety of problems with obtaining CSAT data.

One issue is that CSAT survey data is sparse in that only a small percentage of customers respond to surveys. Some studies suggest that only about 2% to 6% of customers respond to CSAT surveys.

Another issue is CSAT survey data can suffer from bias. For example, it's often the customers with the most extreme experience who respond to CSAT surveys. This can skew CSAT data.

Still yet another issue is that CSAT survey data may not always be available. For example, sometimes different service providers support different components of a contact call center solution. One or more parties may not necessarily have access to the CSAT survey data.

Keeping customers satisfied is a vital part of many businesses. And yet, the conventional tools to determine customer satisfaction have many problems. Embodiments of this disclosure were developed in view of these and other problems and drawbacks in the prior art.

### SUMMARY

A call center utilizes an inference engine to predict customer satisfaction (CSAT) for each call based on a call transcript and call attribute data. In one implementation of a method, transcripts of customer support calls and associated call attribute data are provided as inputs to an inference engine having an artificial intelligence model trained to predict CSAT for each call based on a call transcript and call attribute data for each call. For example, for an instance of an individual call, the CSAT may be predicted in terms of a predicted level within a set of at least two levels. If there are multiple instances to form statistics, CSAT scores in terms of a percentage of favorable CSAT results may also be calculated. The predicted CSAT instances may be used to generate reports on customer satisfaction. As an example, the predicted CSAT may be analyzed to identify root cause factors for CSAT scores. As another example dynamic changes over time in CSAT scores may be identified.

It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1A is a block diagram illustrating a high level system predicting customer satisfaction in a contact call center in accordance with an implementation.

FIG. 1B is a block diagram illustrating an implementation of a predicted customer satisfaction inference module and an analytics module of FIG. 1A in accordance with an implementation.

FIG. 2 is a block diagram illustrating a server-based implementation of the system in accordance with an implementation.

FIG. 3 is a diagram illustrating training of an AI model in accordance with an implementation.

FIG. 4 is a flow chart of an example general method for generating and using predicted CSAT scores in accordance with an implementation.

FIG. 5A is a flow chart of an example method for performing root cause analysis based on predicted CSAT scores in accordance with an implementation.

FIG. 5B is a flow chart of an example method for generating alerts based on dynamic changes to predicted CSAT scores in accordance with an implementation.

FIG. 5C is a flow chart of an example method for using predicted CSAT score to generating agent-related information and routing in accordance with an implementation.

FIG. 5D is a flow chart of an example method of generating dashboard metrics for predicted CSAT scores in accordance with an implementation.

FIG. 5E is a flow chart of an example method for using predicted CSAT scores to determine actions for unsatisfied customers in accordance with an implementation.

FIG. 5F is a flow chart of an example method for generating a dashboard display of relationships between CSAT scores and one or more natural language factors in accordance with an implementation.

FIG. 6 illustrates predicted CSAT scores by longest hold time in accordance with an implementation.

FIG. 7 illustrates predicted CSAT scores by month in accordance with an implementation.

FIG. 8 illustrates predicted CSAT scores for calls where custom moments occur in accordance with an implementation.

FIG. 9 illustrates predicted CSAT scores by month in accordance with an implementation.

FIG. 10 illustrates predicted CSAT scores for calls mentioning products or organizations in accordance with an implementation.

FIG. 11 illustrates a user interface for defining trigger words or phrases in accordance with an implementation.

FIG. 12 illustrates CSAT score by total hold time on call in accordance with an implementation.

FIG. 13 illustrates CSAT score vs total hold time on call in accordance with an implementation.

FIG. 14 illustrates CSAT score vs. agent pre-hold language in accordance with an implementation.

### DETAILED DESCRIPTION

The present disclosure describes systems and method for predicting CSAT scores in a call center, as well as analyzing the CSAT scores to support enhanced analytics.

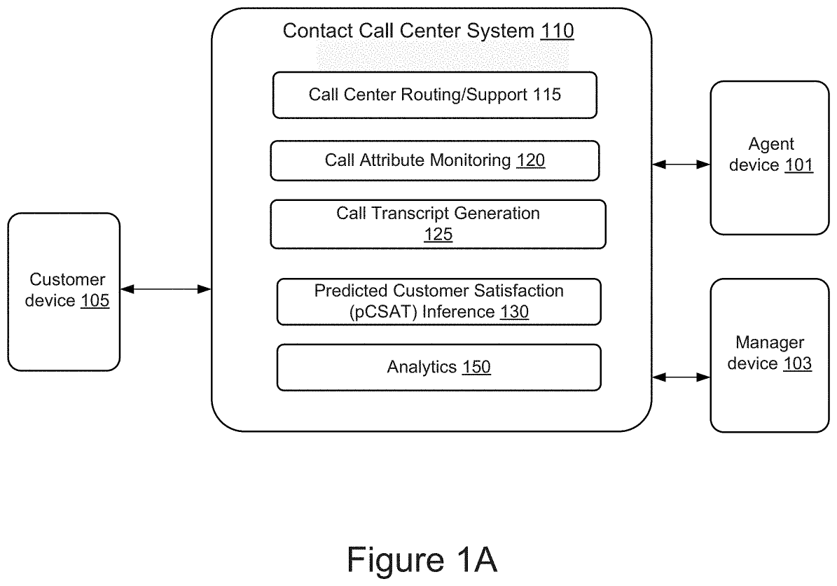

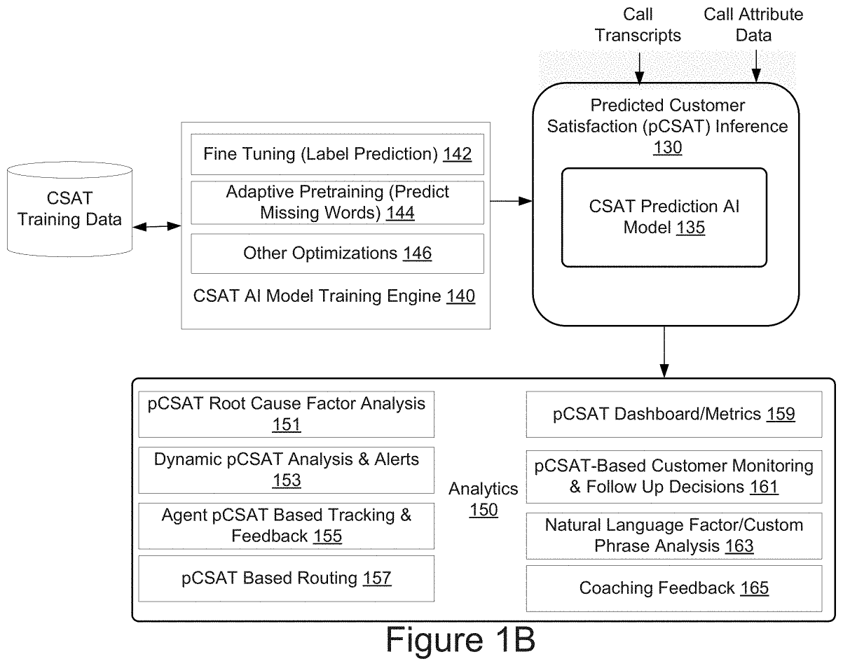

FIG. 1A is a high level block diagram of a contact call center system 110, which may be implemented as a network-based server system, an Internet-based web-server system, or a cloud-based or cloud-assisted service as a few examples. Customers communicate with the contact call system 100 via customer device 105. For example, a customer may communicate via a voice-link, video conference link, or a text (chat) link from a customer device 105 that may be a smartphone, tablet device, or laptop computer as a few examples.

A customer with an issue is routed to an agent at an agent device 101 where the agent device may, for example, be a computer. In practice, there may be a pool of agents (e.g., agents 1, 2 . . . M) and a customer is routed to an available agent based on one or more criteria. One or more managers may monitor ongoing conversations or access data regarding past conversation via a manager device (e.g., a computer). A call center routing and support module 115 may be provided to support routing of customer queries.

Call attribute monitoring 120 may be performed. This may include, for example, monitoring attributes of the call that correlate with customer satisfaction. As one example, call wait times may be indicative of customer satisfaction. For example, a customer put on endless hold may become very angry or frustrated. Research by the inventors indicates that longer hold times result in lower CSAT scores. Customers placed on hold quickly became less satisfied. There is a surprisingly quick drop in CSAT scores as hold time increases beyond a few minutes. Hold times can be broken up into multiple holds, i.e., a single long hold versus multiple holds in which the agent periodically checks in with the customer. Research by the inventors indicates that breaking up long holds (e.g., longer than 3 minutes) in a series of holds improves CSAT scores. Changing the language agents use to explain a hold also matters in what's called pre-hold language. Wait times (the time it takes a customer to wait before any interaction with an agent), also influence CSAT scores. Attributes like wait time, hold time, number of holds, total hold time, and language used by agents to explain holds can be measured and quantified as call attributes. Additional examples of call attributes are described further below in more detail.

A call transcript generation module 125 generates transcripts of a call. As previously discussed, a call can be a voice call or a videoconference call such that voice-to-text technology may be used to generate a transcript. However, more generally there are examples of contact centers that service client questions using at least one of text messaging, email, and chat. There are also hybrid systems that use text messaging, chat, or email followed by a later voice call. It will thus be understood that a transcript can also include the text generated in one or more of text messaging, chat sessions, and email.

A predicted customer satisfaction inference engine 130 generates a prediction of the CSAT for a call based on the transcript. Additionally, in some implementations the predicted customer satisfaction inference engine 130 also uses call attributes for the call in addition to the call transcripts. In one implementation, the prediction is a binary high/low customer satisfaction. That sort of binary prediction with two levels simplifies training and analysis with a comparatively modest amount of CSAT survey data because the classification is simple. A binary classification aids in using an entire transcript to predict CSAT. Of course, more complicated classification schemes are possible, but would have associated tradeoffs. For example, a 1 to 5 scale may be used in an alternate implementation, where 1 is the lowest satisfaction and 5 is the highest satisfaction.

The predicted CSAT (pCSAT) for an individual instance of a call is a predicted level within a scale with two or more level (e.g. low or high in terms of a binary scale; a level from lowest to highest in a 1 to 5 scale, etc.). The predicted level could be considered a score for an individual call, but more conventionally CSAT scores correspond to a percentage of satisfied customers. For multiple instances of calls, the predicted CSAT levels from a group of calls may be used to calculate CSAT scores in terms of the more conventional meaning of CSAT scores as a percentage of customers having a satisfactory customer experience. For example, the predicted CSAT from multiple call instances may be used to calculate a CSAT score in terms of percentage based on 100 multiplied by the number calls with a satisfactory CSAT divided by the total number of calls. As described below in more detail, additional analytics may be used to analyze CSAT data sets and generate information on how CSAT scores (in terms of percentages of satisfactory CSAT results) vary based on different factors, as well as generating various CSAT metrics (e.g., information useful to understand current CSAT scores, factors influencing CSAT scores, changes to CSAT scores, alerts, warnings, etc.) that can be displayed.

An analytics module 150 performs one or more operations to analyze the predicted CSAT scores and generate information to aid in understanding and/or improving customer satisfaction.

In some implementations, components 115, 120, 125, 130, and 150 of system 110 are implemented in software code stored on a non-transitory computer readable medium executable by one or more processors. The system 110 may also have conventional hardware components and communication interface to support basic call center operations.

FIG. 1B illustrates in more detail, aspects of some of the components of FIG. 1A in accordance with an implementation. In one implementation, the pCSAT inference module 130 include a CSAT prediction artificial intelligence (AI) model that receives call transcripts and in response generates a predicted CSAT score. However, in some implementations call attribute data is also used by the AI model in addition to call transcripts.

A CSAT AI model training engine 140 may be provided to train the CSAT prediction AI model 135. CSAT training data may include, for example, a training data set of call transcripts corresponding to CSAT survey data for the call transcripts, and any optional call attribute data that is available for individual calls. The AI model training may include, for example, fine tuning (e.g., label prediction) 142. For example, an in-domain proprietary data set for training the AI model may include calls labelled with CSAT score. The objective of the training is for the AI model to predict the CSAT given that the AI model has access to all of the information of the transcript.

Other forms of training may also be used, such as adaptive pretraining (to predict missing words) 144. For example, a large number of call center calls without CSAT labels may be used to train the AI model to better understand the language used in call centers. The objective of such training is for the AI model to predict words in a sentence given other words in the same sentence.

Other optimization 146 may also be performed. As one example, some experiments by the inventors suggest that there are differences in how an AI model interprets transcripts by optimizing factors such as whether punctuation is considered in a transcript and whether the case (lower case vs upper case) typographical forms are used. Such seemingly minor typographical variations in how a transcript is interpreted may make a difference in prediction accuracy. Other optimizations include considered call attributes such as hold time and wait time. As yet other examples of an optimization, sentiment analysis may be considered in the training. Still other optimizations include optimizing hyperparameters, selecting oversampling vs. non-oversampling, partitioning training, development and testing by call identification parameters, token size, and use of different AI tools, such as choosing between BERT vs. XLNet.

The analytics module 150 may include one or more submodules to implement analytical functions. An example of sub-modules includes a pCSAT root cause factor analysis module 151, to identify factors influencing pCSAT scores. Understanding the factors that influence CSAT scores is important for management and operation of a call center. For example, at any given time, some factors may influence pCSAT scores more than others and be relevant to various management and operational decisions, such as increasing agent staffing, performing additional agent coaching or training, etc.

A dynamic pCSAT analysis & alerts module 153 generates alerts for dynamic changes to CSAT. For example, CSAT scores may change on a daily, weekly, or monthly basis. Generating metrics/alerts on dynamic changes is useful for managing a call center and proactively identifying potential problems. For example, dynamic alerts may be based on triggers of pre-selected pCSAT scores, time rate of change of pCSAT scores, etc.

An agent pCSAT based tracking & feedback module 155 may track individual pCSAT scores of individual agents, generate feedback for individual agents based on the pCSAT scores of their calls, etc. For example, the agent associated with an individual transcript may also be monitored for tracking purposes. Predicted CSAT scores may be presented for groups of agents, and changes in pCSAT scores for individual agents may be tracked. Such information may be useful, for example, for a variety of purposes such as identifying potential burnout in agents or the need for additional staffing or training.

A pCSAT based routing module 157 may make a decision to route customer conversations to agents based on pCSAT. For example, in a dynamic use case, the pCSAT may be monitored during a call, and if the pCSAT is unsatisfactory, route the call to a more experienced agent or to a manager to either participate in the call or take over the call. As another example, a pCSAT score of a customer for a previous call may be used to make a routing decision for a current (new) call. For example, if a customer call had an unsatisfactory pCSAT, the next call may be routed to a different agent, an agent with better training/experience, a manager etc. That is upon identifying that a customer's previous call (or calls) had unsatisfactory pCSAT scores a call may be routed to a class of agents or manager to try to improve the customer's satisfaction. As yet another example, smart call routing may also take into account factors like the tone of voice of the customer (e.g., to determine potential stress on the part of the customer) and the routing performed to match the call to an agent based on factors like the agent's experience, workload, training, freshness (e.g., beginning or end of the agent's workday), or the agent's recent pCSAT scores. That is, a customer who is stressed may be routed to an agent better able to handle a stressed-out customer and more likely to achieve a satisfactory customer experience. As still another example, if the call reason can be identified before connecting the caller to an agent, e.g., using speech recognition and natural language processing (NLP to infer the call reason in the interactive voice response (IVR) stage, then the can be routed to the agent with the highest pCSAT for that particular call reason. That is the call can be routed to the available agent with the best ability to solve that particular issue.

A pCSAT dashboards/metric module 159 is provided to generate metrics for a dashboard display. For example, in some implementations, a dashboard generates a selection of pCSAT metrics, graphs, or charts. The dashboard may, for example, permit a user to select specific metrics to be displayed, display format, etc.

A pCSAT based customer monitoring & follow up decision module 161 is provided to monitor and make follow up decisions for individual customers. For example, customers associated with an individual transcript may be tracked. Customers whose pCSAT is unsatisfactory may be identified for follow up actions (e.g., follow up calls, apologies, etc.). This permits, for example, the possibility of a mode of operating a call center in which all calls which have an unsatisfactory pCSAT score have proactive follow up, regardless of whether the customer fills out a conventional CSAT survey.

A natural language factor/custom phrase analysis module 163 may perform analysis of pCSAT scores for selected words or phrases. For example, pCSAT scores may correlate with particular product names, company names, etc. As one example, a user may define a trigger in the form of a preidentified word or phrase that appears during a call, what the inventors call a “custom moment.” In some implementations, the preidentified word or phrase may be selected via a user interface. In one implementation, it may be further specified whom said the preidentified word or phrase (e.g., by the customer; by the agent; or by either the customer or agent)

A coaching feedback module 165 may generate coaching feedback for individual agents or groups of agents. For example, a coaching feedback module 165 may identify individual agents with below-average pCSAT scores, identify agents with consistently high pCSAT scores, etc.

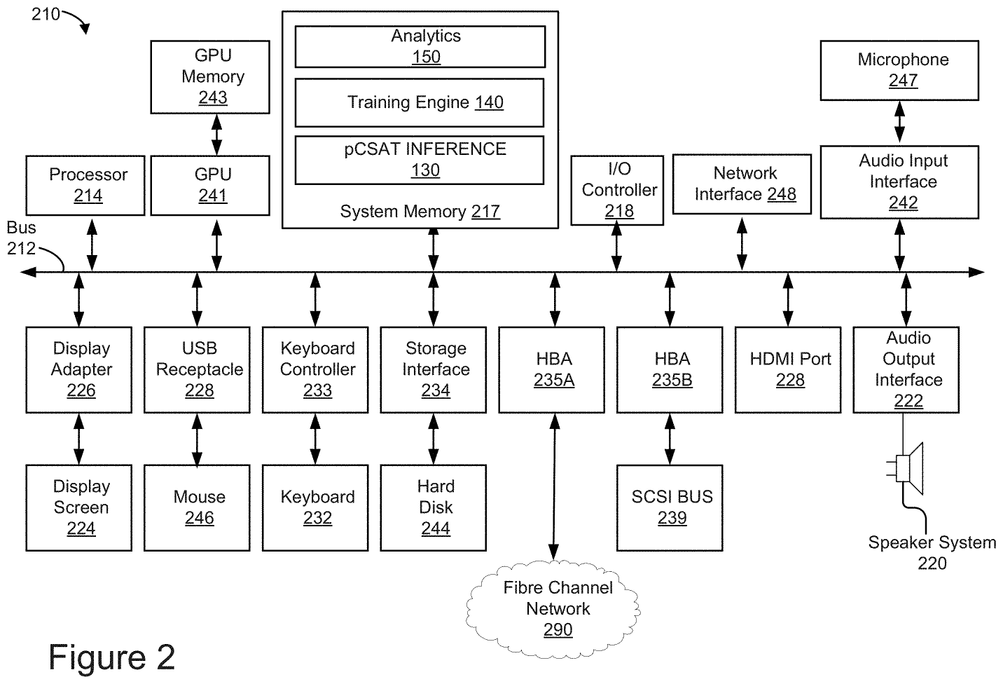

FIG. 2 illustrates an example server-based implementation. A system memory 217 may store computer program instructions for pCSAT inference module 120, training engine 140, and analytics 150. For example a bus 212 may couple various components together. Referring to the upper portion of the figure, some of the components may include a processor 214, GPU 241 and associated GPU memory 243, I/O controller 218, network interface 248, audio input interface 242 and microphone 247. Referring to the bottom portion of the figure, other components may include a display adapter 226 and display screen 224 a USB receptacle 228 and mouse 246, a keyboard controller 233 and keyboard 232, a storage interface 234 and hard disk 244, a host bus adapter 235A and fibre channel network 290, a host bus adapter 235B and SCSI bus 239, a HDMI port 228, and an audio output interface 222 and speaker system 220.

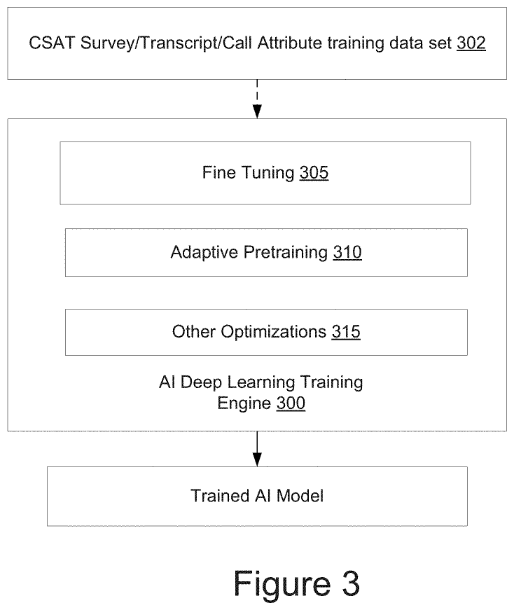

FIG. 3 is a diagram illustrating training of the AI module in accordance with an implementation. CSAT survey data, transcripts, and call attribute data is provided as a training data set 302. The training data is used by an AI deep learning training engine 300, with the training including fine tuning 305, optional adaptive pretraining 310, and optional other optimization 315. Regarding optional optimization 315, some research by the inventors suggest that taking into account different typographical variations (e.g. taking into account punctuation and capitalization) may make a difference.

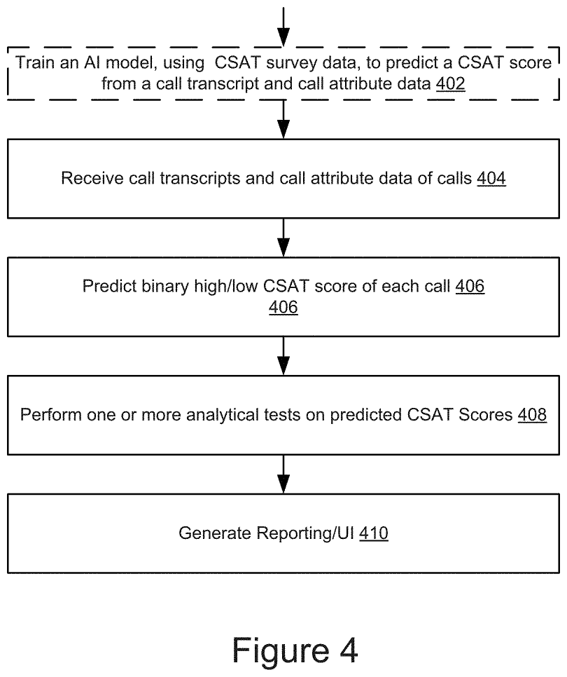

FIG. 4 is a flowchart of a general method of using the trained AI model in accordance with an implementation. In the pre-step of block 402, the AI model is trained to predict a CSAT score from a call transcript and call attributes. In block 404, the AI model receives the call transcript and call attributes 404. In block 406, the AI model predicts a binary high/low CSAT level/scores for each call. For a collection of multiple instances of calls, the individual CSAT levels/score may be used to generate a predicted CSAT score in terms of a percentage of satisfied customers. In block 408, one or more analytical tests are performed on the predicted CSAT scores. In block 410, reports and/or a dashboard user interface are generated.

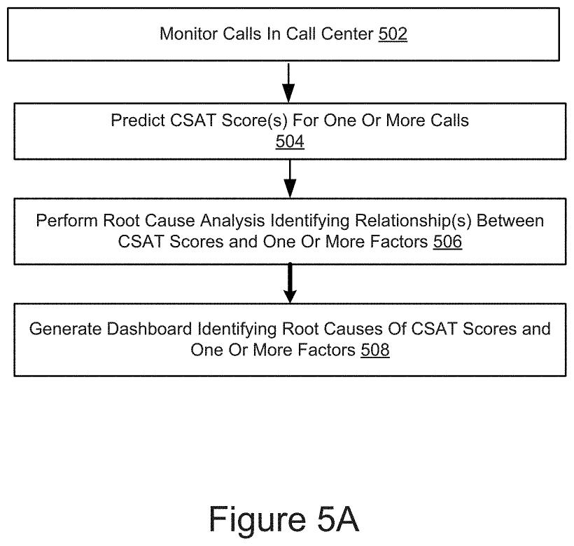

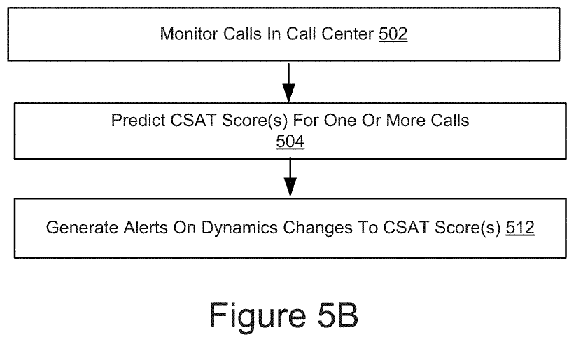

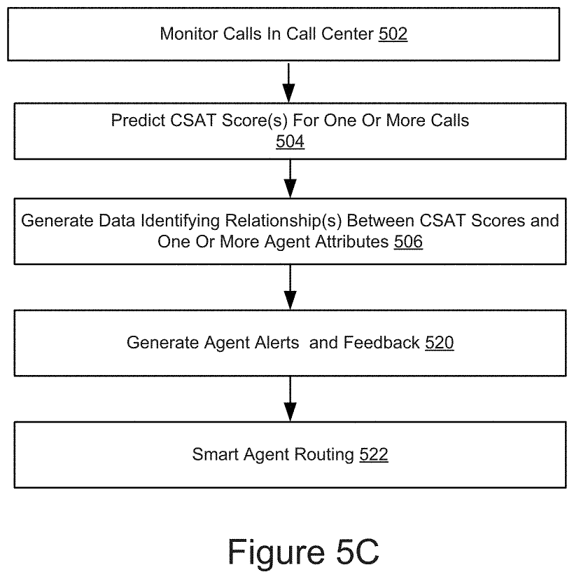

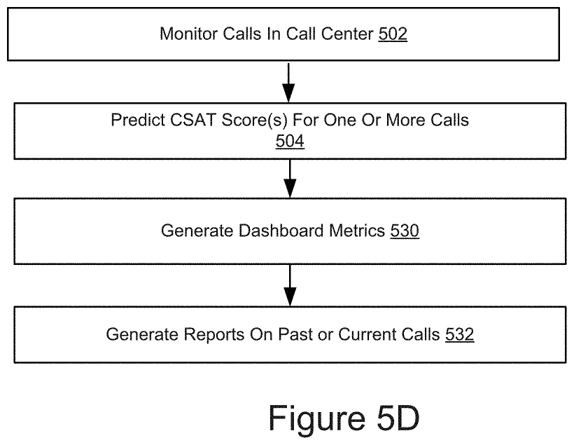

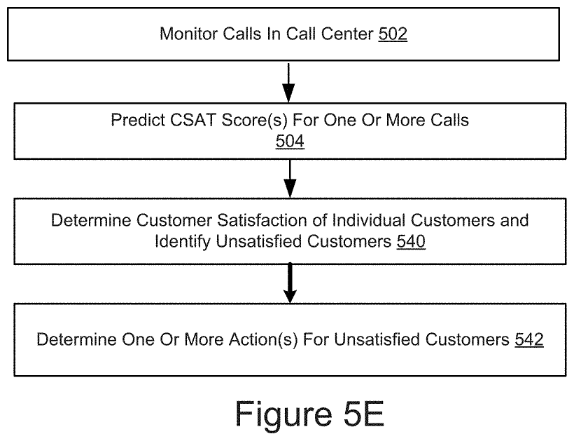

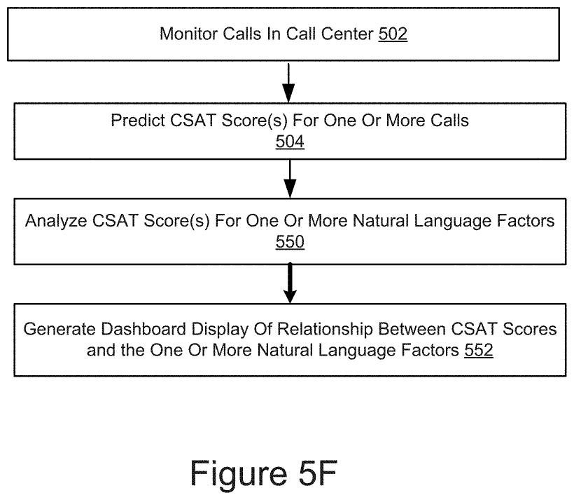

FIG. 5A is a flowchart of a method generating a CSAT root cause analysis in accordance with an implementation. In block 502, calls in a call center are monitored. In block 504, CSAT scores are predicted for one or more calls using the trained AI model and the call transcripts and call attributes. In block 506, root cause analysis is performed to identify relationship(s) between CSAT scores and one or more factors. For example, a set of factors (e.g., hold time, wait time, etc.) may be selected for performing a causal inference determination. In block 508, a dashboard is generated identifying root causes of CSAT scores and one or more factors.

FIG. 5B is a flow chart illustrating a method of generating alerts on dynamic changes to CSAT scores. In block 502, calls are monitored in a call center. In block 504 CSAT scores are predicted for one or more calls based on transcripts and call attributes of the calls, using the trained AI model. In block 512, alerts are generated for dynamic changes to CSAT scores. As examples, threshold levels for alerts may be defined or a rate of change alert may be defined.

FIG. 5C is a flow chart of a method agent tracking, alerts, and feedback. In block 502, calls are monitored in a call center. In block 504, CSAT scores are predicted for one or more calls based on call transcripts and call attributes provided to the AI model. In block 506 causal inference data identifying relationships between CSAT scores and one or more agent attributes. For example, relationships between CSAT scores and individual agents may be performed. More generally, relationships of CSAT scores with other agent attributes (e.g., agent training, agent experience) may be identified. In block 520, agent tracking alerts are generated. In some implementations, smart agent routing of customer communication is performed.

FIG. 5D is a flow chart of a method of generating reports on past or current calls. In block 502, calls are monitored in a call center. In block 504, CSAT scores are predicted for one or more calls based on call transcripts and call attributes provided to the trained AI model. In block 530 dashboard metrics are generated based on the predicted CSAT scores. In block 532, reports are generated for past or current calls. For example, metrics on CSAT scores may be displayed for different time periods.

FIG. 5E is a flow chart of a method of determining one or more actions for unsatisfied customers. In block 502 calls are monitored in a call center. In block 504, CSAT scores are predicted for one or more calls based on call transcripts and call attributes provided to the AI model. In block 540, customer satisfaction is determined for individual customers and unsatisfied customers are identified. This identification may be based on the predicted CSAT score of individual calls but may also take into account other available information (e.g., pCSAT scores of previous calls), purpose of a call (e.g., “return” or “refund”), etc. In block 542, one or more actions are determined for unsatisfied customers. For example, follow up emails may be sent, follow up calls may be made by agents/manager experienced in dealing with unsatisfied customers.

FIG. 5F is a flowchart of a method of generating a display of relationships between CSAT scores and one or more natural language factors. In block 502, calls are monitored. In block 504, CSAT scores are predicted for one or more calls based on call transcripts and call attributes. In block 550, predicted CSAT scores are analyzed using one or more natural language factors, where the natural language factors may include a word or a phrase, such as a company or organization name. In block 552, a dashboard display is generated of the relationship between CSAT scores and one or more natural language factors.

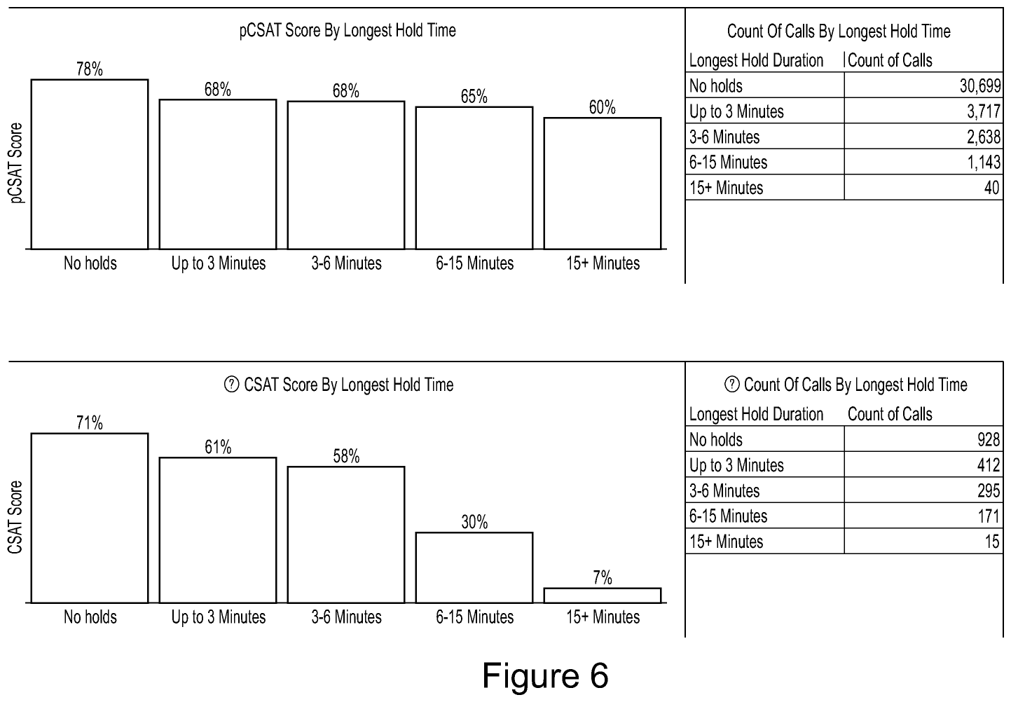

FIG. 6 illustrates predicted CSAT scores (top) and measured CSAT scores (bottom) by longest hold time in accordance with an implementation. The measured CSAT scores are sparse. The predicted CSAT scores, in contrast, can be generated for all calls.

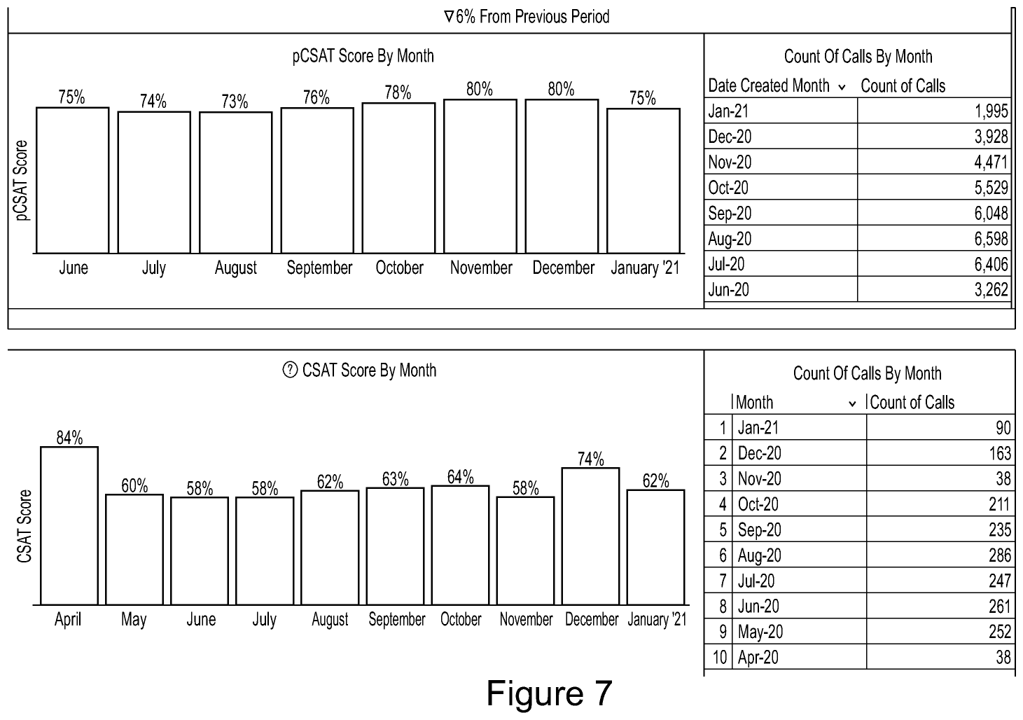

FIG. 7 illustrates predicted CSAT scores by month (top) and CSAT scores by month (bottom) in accordance with an implementation. The measured CSAT scores are sparse. The predicted CSAT scores, in contrast, can be generated for all calls.

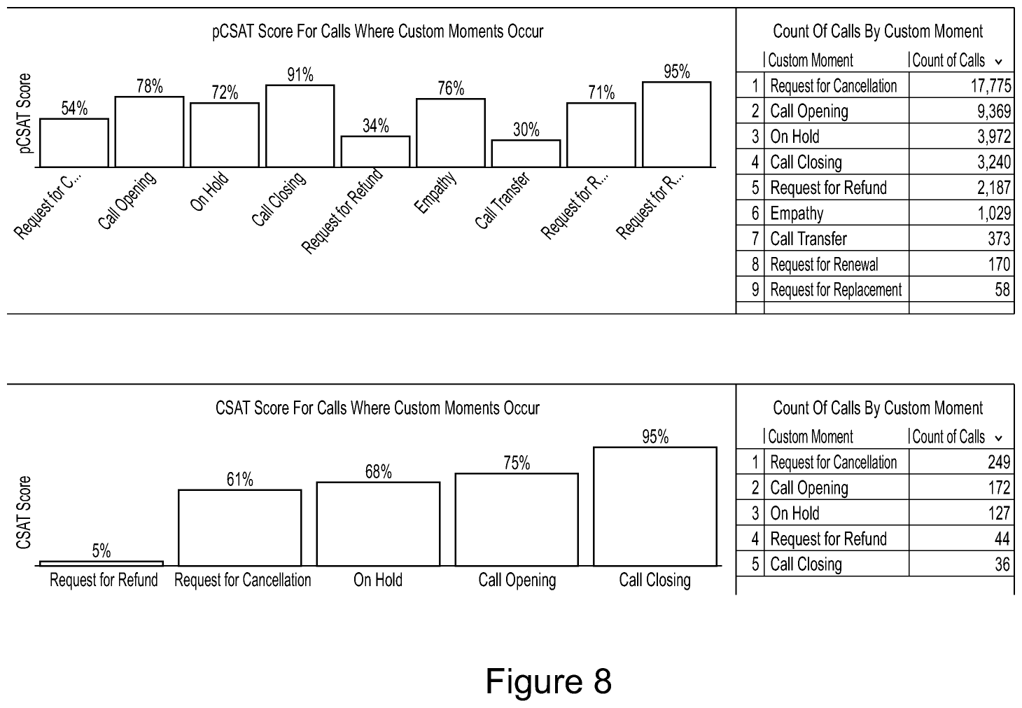

FIG. 8 illustrates predicted CSAT scores for calls where custom moments occur (top) and CSAT scores where custom moments occur in accordance with an implementation. The measured CSAT scores are sparse. The predicted CSAT scores, in contrast, can be generated for all calls.

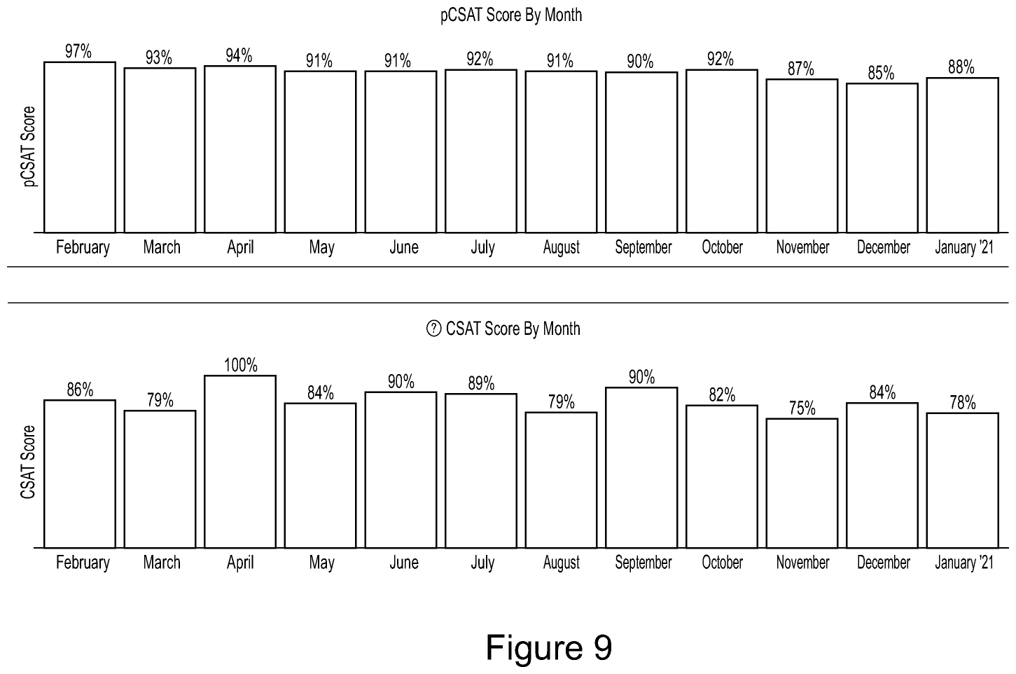

FIG. 9 illustrates predicted CSAT scores by month (top) and measured CSAT scores by month (bottom) illustrating another example of how there may be different results between the pCSAT generated for all calls versus the sparse measured data for CSAT from surveys.

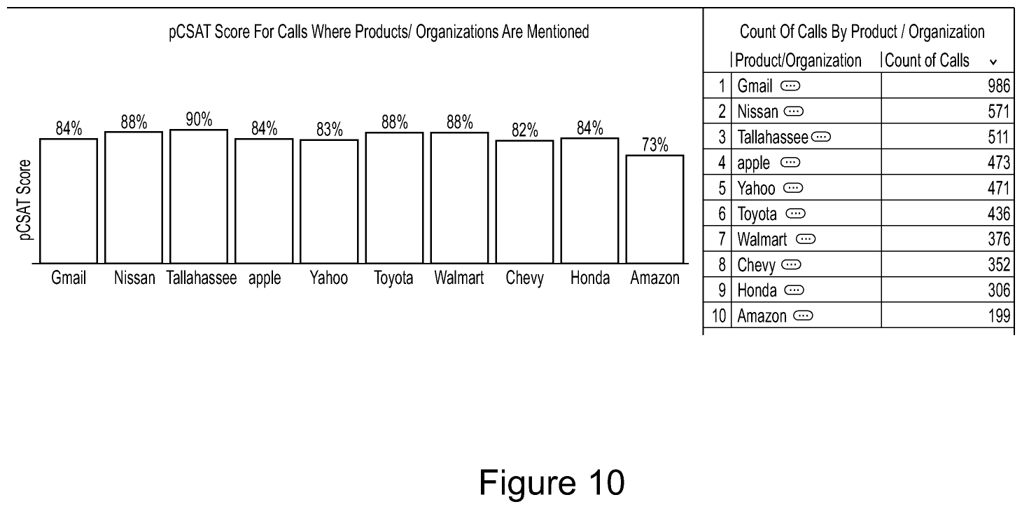

FIG. 10 illustrates predicted CSAT scores for calls mentioning products or organizations in accordance with an implementation. For example, bar graphs illustrating pCSAT scores associated with calls mentioning specific words or phrases corresponding to products or organizations is illustrated.

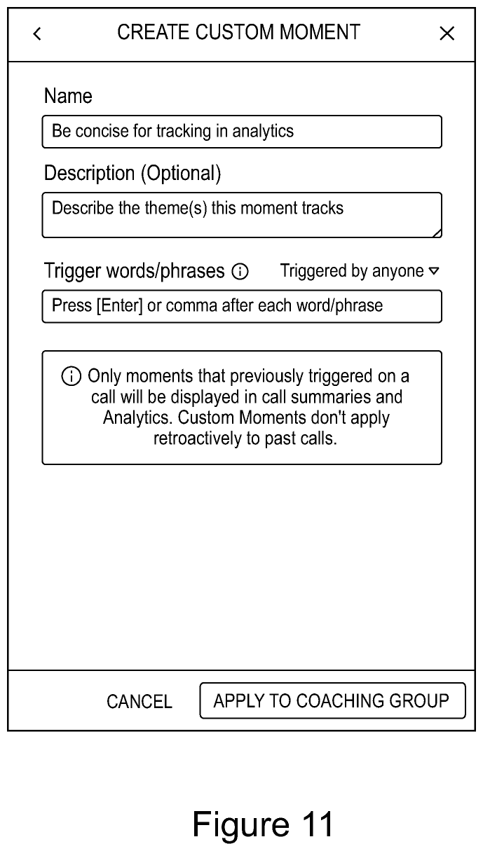

FIG. 11 illustrates a user interface for defining trigger words or phrases in accordance with an implementation. In one implementation, a user can select trigger words or phrases to define a custom moment.

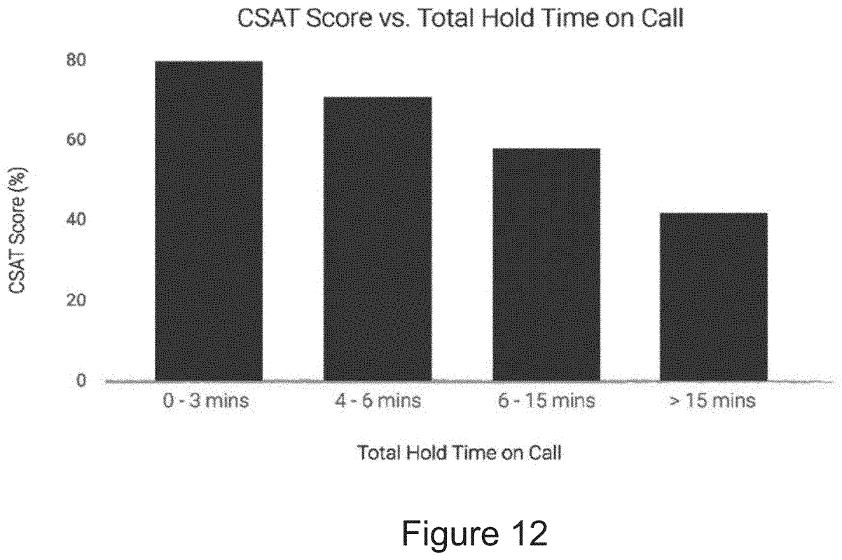

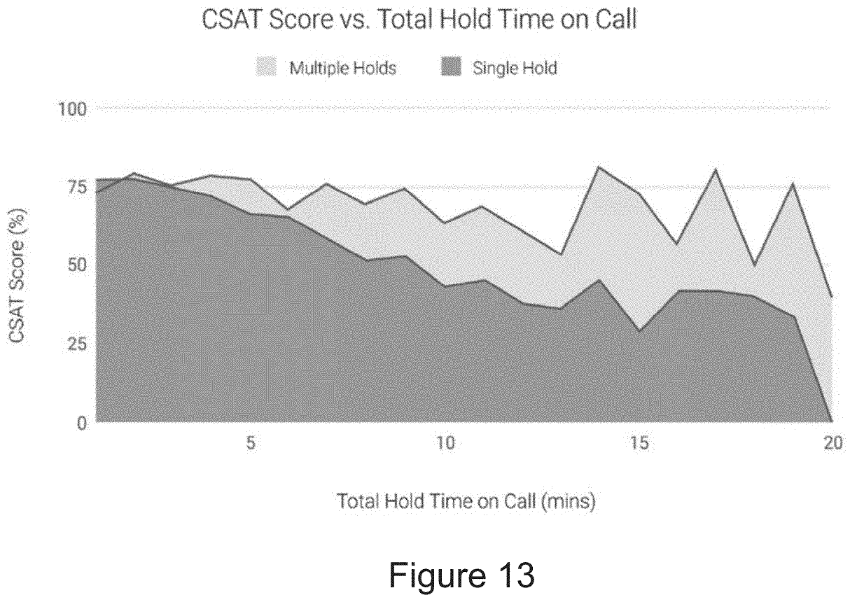

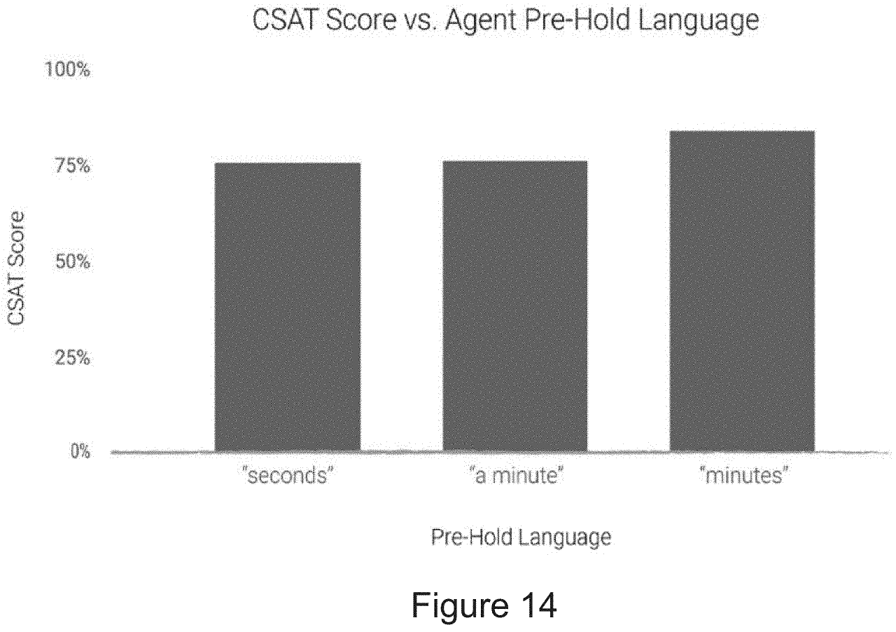

FIG. 12 illustrates research by the inventors on how CSAT scores are influenced by total hold time. Such empirical investigations demonstrate that CSAT scores drop for progressively longer hold times. FIG. 13 illustrates research by the inventors on how CSAT scores are changed by breaking up a single total hold time into multiple holds in which an agent periodically checks in with a customer. FIG. 14 illustrates research by the inventors on how CSAT scores vary based on the agent's pre-hold language regarding when the agent promises to get back to the customer.

A pCSAT dashboard may be implemented in different ways. In one implementation, it includes a highlights UI section, an agent leaderboard UI section, a wait time UI section, a hold time UI section, a call purpose UI section, a product/organization UI section, and a custom moments UI section.

As one example, a highlights UI section may provide highlights of any changes to CSAT or metrics affecting CSAT (such as hold times, wait times) per month or per quarter as examples. A variety of overview plots may be presented, Examples include plotting CSAT score and call volume by month. Another example is plotting CSAT score and average call duration, average hold time, and average speed to answer per month.

As an example of an agent leaderboard UI section, agent names may be displayed along with a number of calls handled by an agent in a relevant time period and their overall pCSAT scores.

An example of a wait time UI section, the pCSAT score may be plotted as bar graphs versus wait time before an agent first picks up (e.g., 0 to 30 seconds, 30 to 60 seconds, 1 to 2 minutes, 2 to 6 minutes, etc.) over a relevant time period (e.g., calls for a given month quarter, or year).

An example of a hold time UI section may plot bar graphs of pCSAT score by longest in-call hold time (e.g., 0 to 30 seconds, 30 to 60 seconds, 1 to 2 minutes, 2 to 6 minutes, etc.) over a relevant time period (e.g., calls for a given month, quarter, or year).

An example of a purpose of call UI section includes plotting pCSAT score for different call purposes (e.g., “help account”; “cancel account”; “add account”; “sign up for trial”, etc.). Various plots of pCSAT scores may be plotted for different call purposes as a function of factors such as average call duration, call hold time, etc.

An example of a product/organization section UI section plots pCSAT scores for call where a selection of top products/organizations are mentioned. For example, a selection of 10, 20, or some other number of top products/organization may be chosen.

An example of a custom moments UI section may include bar graphs of pCSAT scores for calls where custom moments occur. Plots of pCSAT scores per month or per quarter for different custom moments may be generated.

Further extensions of the UI are possible. One aspect of the pCSAT generation and UI is that it provides agents and managers of a call center a wide variety of information and feedback that was impractical using survey-based CSAT techniques.

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware.

Reference in the specification to “one embodiment”, “some embodiments” or “an embodiment” means that a particular feature, structure, or characteristic described in connection with the embodiment is included in at least some embodiments of the disclosed technologies. The appearances of the phrase “in some embodiments” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers, or the like.

These and similar terms can be associated with the appropriate physical quantities and can be considered labels applied to these quantities. Unless specifically stated otherwise as apparent from the prior discussion, it is appreciated that throughout the description, discussions utilizing terms, for example, “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer.

The disclosed technologies can take the form of an entirely hardware implementation, an entirely software implementation, or an implementation containing both software and hardware elements. In some implementations, the technology is implemented in software, which includes, but is not limited to, firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware, or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A computer-implemented method of operating a call center, comprising:
providing transcripts and call attribute data of customer support calls as inputs to an inference engine having an artificial intelligence model trained to predict customer satisfaction (CSAT) for each call based on a call transcript and call attribute data for each call; and
analyzing the predicted CSAT, from one or more calls, to generate reports on customer satisfaction.

2. The computer implemented method of claim 1, wherein analyzing the predicted CSAT comprises analyzing the predicted CSAT for multiple calls and identifying root cause factors for at least one CSAT metric.

3. The computer implemented method of claim 1, analyzing the predicted CSAT comprises analyzing the predicted CSAT for multiple calls and identifying dynamic changes over time for at least one CSAT metric.

4. The computer implemented method of claim 1, analyzing the predicted CSAT comprising generating CSAT reports for past or current calls.

5. The computer implemented method of claim 1, wherein the artificial intelligence model is trained based on a training data set of CSAT survey data and associated call transcripts and call attribute data.

6. The computer implemented method of claim 5, wherein the training comprises fine tuning to predict a label.

7. The computer implemented method of claim 6, wherein the artificial intelligence model is further configured to perform adaptive pretraining to predict missing words.

8. The computer implemented method of claim 6, wherein the artificial intelligence model performs at least one optimization in interpreting a typographical aspect of the transcript.

9. The computer implemented method of claim 1, wherein analyzing the predicted CSAT comprises analyzing the predicted CSAT for multiple calls by at least one factor selected from the group consisting of determining predicted CSAT scores by month, by longest call hold time, by wait time, by mentioning of specific products or organization, and by custom phrase.

10. The computer implemented method of claim 1, wherein analyzing the predicted CSAT comprises analyzing predicted CSAT scores by agent behavior by at least one member selected from the group consisting of hold time, interruptions, follow up, empathy, issue escalates, issue resolved, and agent getting back with answer.

11. The computer implemented method of claim 1, wherein analyzing the predicted CSAT comprises analyzing the predicted CSAT by a natural language factor including at least one member selected from the group including purpose of call, sentiment, named entity, and custom moments.

12. The computer implemented method of claim 1, wherein analyzing the predicted CSAT comprises analyzing the predicted CSAT by call center properties including wait time and call drops.

13. The computer implemented method of claim 1, wherein analyzing the predicted CSAT comprises analyzing the predicted CSAT score by customer intent.

14. The computer implemented method of claim 1, wherein the artificial intelligence engine is trained to generate a binary high or low classification of CSAT for individual calls.

15. A method of operating a call center, comprising:
receiving, in an inference engine, transcripts of calls and call attribute data for calls between customers and customer support agents of the call center;
predicting, by an Artificial Intelligence model of the inference engine trained to classify customer satisfaction (C SAT) from the call transcripts and call attribute data, at least two different CSAT levels;
providing the predicted CSAT levels for each call to an analytics engine; and
generating, by analytics engine, a root cause analysis of factors influencing the predicted CSAT.

16. The method of claim 15, further comprising identifying, by the analytics engine, changes over time in CSAT scores.

17. The method of claim 15, further comprising identifying, by the analytics engine, actions to follow up with dissatisfied customers.

18. The method of claim 15, further comprising performing, by the analytics engine, an agent routing decision based on predicted CSAT.

19. A computer implemented method, comprising:
providing a deep learning artificial intelligence model trained to predict customer satisfaction of calls in a call center by classifying the calls into at least a high level of satisfaction and a low level of satisfaction based on call transcripts and call attribute data;
receiving call transcripts and call attribute data;
using the deep learning artificial intelligence model to predict customer satisfaction of calls based on received call transcripts and call attribute data; and
analyzing the levels of customer satisfaction to generate reports on customer satisfaction.

20. The computer implemented method of claim 19, wherein the deep learning intelligence model is trained using fine tuning and adaptive pre-training.
